(19) United States
(12) Patent Application Publication
(10) Pub. No.: US 2007/0132639 A1
(43) Pub. Date: Jun. 14, 2007

(54) Method and apparatus for determining an approximate position of a satellite positioning receiver

(76) Inventors: Jose E. Korneluk, Boynton Beach, FL (US); Bobby D. Anderson, Gilbert, AZ (US); Kristi A. Haverkamp, Chandler, AZ (US); Keith M. Klug, Mesa, AZ (US); Charles H. Segerson, Tempe, AZ (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/297,909

(22) Filed: Dec. 9, 2005

(51) Int. Cl. G01S 3/02; G01S 5/14

(52) U.S. Cl. 342/464; 342/357.15

(57) ABSTRACT

A mobile device (100) includes a satellite positioning receiver (102) for determining a precise location of the device (220). The first time the precise location is determined, the satellite positioning receiver is provided with location aiding information including an approximate location and a radius of uncertainty. The approximate location is determined by acquiring the location of a present base station (202), and the locations of one or more neighbor base stations (306), and calculating the spatial center of the base stations, and adjusting the spatial center according to received signal strengths of the base stations. A radius around the approximate location is then determined. The approximate location and radius are provided to the satellite positioning receiver.

### TECHNICAL FIELD

This invention relates in general to satellite positioning receivers, and more particularly to satellite positioning receivers used in conjunction with mobile communication devices and in mobile communication networks.

### BACKGROUND OF THE INVENTION

Mobile communication devices are in widespread use throughout metropolitan regions of the world. These devices are increasingly common and affordable, and to remain competitive manufactures have sought to include additional functionality in them. For example, manufacturers are now including positioning receivers in mobile communication devices to support a number of location applications, such as location reporting for emergency services, and navigation.

The use of satellite positioning receivers in mobile communication devices was initially driven by safety concerns related to locating a person calling emergency services using a mobile communication device. Although it is simple to determine the cell location of a mobile caller, the area encompassed by a cell may be quite large, especially in rural areas. Therefore some governments are now requiring that mobile communication devices include a means for determining their own location and reporting it when necessary, such as when the mobile communication device user calls an emergency phone number. Although numerous methods of approximate location determination have been developed, using such techniques as triangulation and relative power levels of signals received from base station radios in the vicinity of the mobile communication device, these methods have not proven sufficiently reliable or precise.

The preferred means of providing location determination in a mobile communication device is to include a satellite positioning receiver. However, this approach is not without significant design challenges. For one, the time needed for a satellite positioning receiver to lock onto a sufficient number of positioning satellite signals from an autonomous or “cold” start can be significant, taking several minutes or more. This is due to the number of unknown variables the satellite positioning receiver must determine when commencing a cold start. For one, the satellite positioning receiver must know which satellites are presently in view to search for the signals transmitted by those satellites, otherwise the positioning receiver must search for each satellite until it determines which ones are presently in view. The ephemeris orbital parameters, and related parameters such as Doppler shift are of significant assistance if known before initiating a location fix. The present time of day and approximate location are very helpful, as well. This type of aiding information may be available from a communication system, and may be transmitted to the mobile communication device from, for example, a base station in a cellular telephony system. Aiding information received from the network is referred to as network aiding. Network aiding will reduce the time to first fix to a few seconds to a minute, depending on signal conditions. Network aiding involves transmitting information to reduce the search time of the satellite positioning receiver, and may include time of day, approximate location, and satellite ephemeris. However, the approximate position aiding provided by the network is typically the surveyed location of the base station. As mentioned previously, cell sizes may encompass very large areas. The location error in a larger rural serving cell may be on the order of 10 miles or more. In cases where no estimator of cell size is known, errors in location aiding accuracy as large as 30 kilometers may be assumed. Reducing the location error in the approximate location can significantly reduce the time necessary to acquire a first fix. Therefore there is a need to reduce the location error when initiating a first fix in a satellite positioning receiver.

### BRIEF DESCRIPTION OF THE DRAWINGS

FIG. 1 shows a block schematic diagram of a mobile device having a satellite positioning receiver, in accordance with an embodiment of the invention;

FIG. 2 shows a flow chart diagram of a method of initiating a location fix in a satellite positioning receiver, in accordance with an embodiment of the invention;

FIG. 3 shows a flow chart diagram of a method of monitoring neighbor base stations, in accordance with an embodiment of the invention;

FIG. 4 shows a mapped polygon for determining an approximate location of the satellite positioning receiver in cellular communication network, in accordance with an embodiment of the invention; and

FIG. 5 shows a cell diagram illustrating how a radius of uncertainty may be determined, in accordance with an embodiment of the invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. The invention solves the problem of reducing location uncertainty by acquiring the location of a present base station with which the mobile device may be affiliated, and then acquiring the locations of neighboring base stations, and determining a polygon formed by the location of the present and neighbor base stations, then determining the center of that polygon, and adjusting the center location based on signals qualities from the base stations to determine an approximate position. The distance between the present base station and the approximate position may be used as a radius of uncertainty around the approximate position.

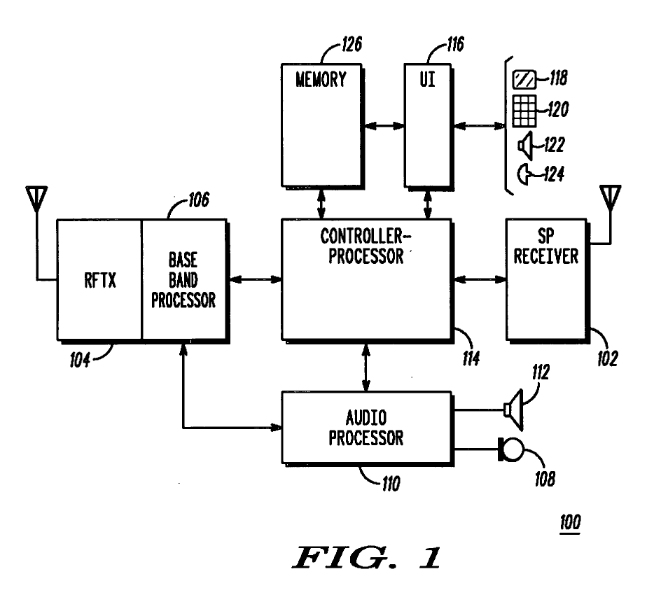

Referring now to FIG. 1, there is shown a block schematic diagram 100 of a mobile device having a satellite positioning receiver 102, in accordance with an embodiment of the invention. The satellite positioning receiver may be any one of a variety of satellite receivers which receive signals from positioning satellites in orbit around the Earth, such as, for example, the global positioning system (GPS). The satellite positioning receiver may be embedded in a mobile communications device, as shown here, or, it is contemplated, may be be a device which includes a cellular communications receiver. According to the present embodiment, the mobile communication device further comprises a cellular communications transceiver 104 for communicating with a cellular communications network via radio waves according to well known frequency and modulation schemes and using known air interface protocols. The cellular communications transceiver 104 is coupled to a baseband processor 106 which, among other things, processes signals for modulation and transmission by the cellular communications transceiver, as well as receiving demodulated signals from the cellular communications transceiver. For example, acoustic audio signals may be received at a microphone 108, which is coupled to an audio processor 110. The audio processor digitizes the acoustic audio signal and provides the digital audio signal to the baseband processor for transmission when the mobile communication device is engaged in a call. Similarly, the baseband processor provides received digital audio signals to the audio processor to be played over a speaker 112.

The satellite positioning receiver, baseband processor, cellular communications transceiver, and audio processor may all be operated under supervision of a main processor or controller processor 114. The main processor 114 further operates a user interface 116 which may include display elements 118, button and keypad elements 120, additional acoustic transducers or speaker elements 122, and vibratory or other tactile elements 124. The main processor operates according to instruction code stored in a collective memory 126, which, as shown here, represents both RAM and ROM elements, as well as semi-permanent and other non-volatile reprogrammable memory elements. The memory 126 may include shared memory used by subsystems of the mobile communication device, such as the baseband processor. The main processor may perform a variety of algorithms and applications, including instantiations of various operating systems and portable code environments such as JAVA 2 Micro Edition (J2ME).

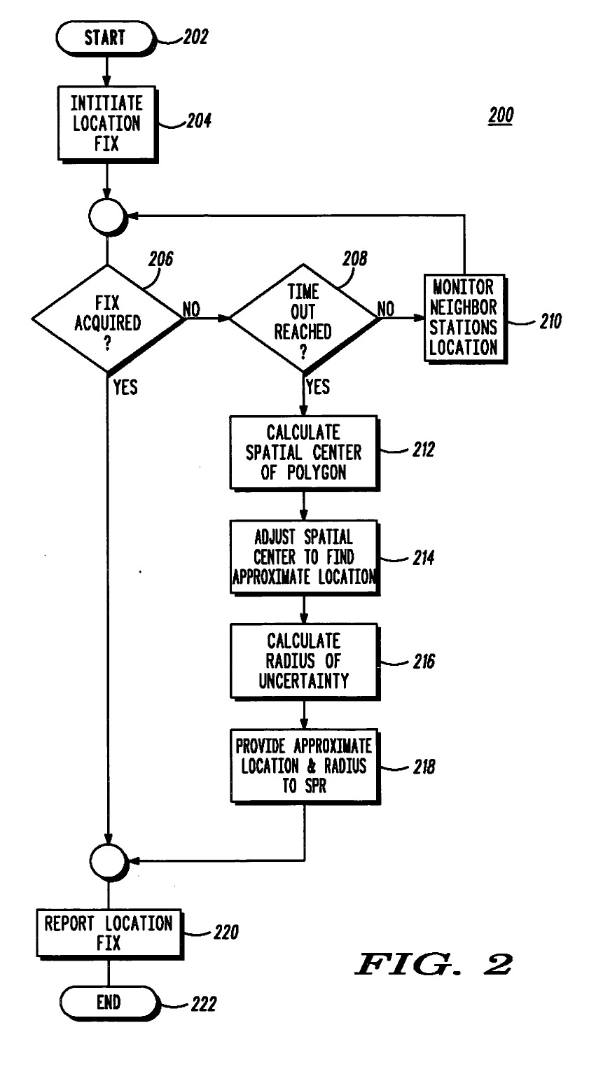

Referring now to FIG. 2, there is shown a flow chart diagram 200 of a method of initiating a location fix in a satellite positioning receiver, in accordance with an embodiment of the invention, using a device similar to that shown in FIG. 1. The processes of the method may be performed by the processor of the device in accordance with instruction code for carrying out the processes and algorithms described herein. At the start 202 the device is powered up and ready to perform an initial location determination. That is, the device has not yet performed an initial location determination, or the previous location determination is so old as to be considered invalid, for example. Thus, the device commences a location determination or fix 204. Upon commencement of the method, the device should have affiliated with a base station of a cellular communications system. In affiliating with base station, the device receives a broadcast of the base station over, for example, a broadcast control channel (BCCH). In the broadcast information is the location of the present base station, and a list of neighbor base stations which establish serving cells adjacent the serving cell established by the present base station. The neighbor list may be in the form of color codes of neighboring base stations which indicate the frequency of operation for each of the neighboring base stations, or, in code division multiple access (CDMA) systems, a pseudorandom noise (PN) sequence offset for each neighbor base station. According to the present embodiment of the method, the method performs a loop where the device first determines if a fix has been acquired 206 since initiating the method Upon initiating the method the satellite positioning receiver may start an autonomous fix, or an aided fix using information received from the present base station, as is known in the art. Assuming no fix has been acquired, the method then determines if a neighbor monitor timer has timed out 208. While the neighbor monitor timer is still pending and while there are still neighbor base stations to check, the device monitors the neighbor base stations listed in the neighbor list of the present base station 210. Monitoring the neighbor base stations includes tuning to the frequency of the broadcast control channel for each of the neighbor base stations, and receiving the broadcast location of each neighbor base station. Additionally, the received signal strength of each neighbor base station is recorded. Once all the neighbor base stations have been checked or upon expiration of the neighbor monitor timer, the device then selects at least one, and preferably two or more of the neighbor base stations. If more than one neighbor base station is selected, the neighbor base stations form a polygon, such as a triangle, with the present base station. The device then determines the spatial center of the polygon 212, or of the line between the present base station and the present base station is only one neighbor base station is used. Once the spatial center has been determined, the device determines an approximate location of the device by adjusting the spatial center according to the received signal strengths of the base stations forming the vertices of the polygon 214, or the line between the present base station and one selected neighbor base station. However, because the approximate position can vary significantly from the actual position due to fluctuations in received signal strength, movement of the device, and so on, the device further determines a radius of uncertainty around the approximate position 216. Once the approximate position and radius of uncertainty are determined, they are provided to the satellite positioning receiver 218. The positioning receiver uses the information to seed a location fix, along with any other aiding information, if provided. Other aiding information may include satellite ephemeris data, time of day, frequency correction information, and so on, as are known. Once the precise location is determined, the satellite positioning receiver reports the position 220 to the processor. The precise location may then be displayed to the user of the device, fed to an application that called for the precise location, report the precise location over the cellular communication network, for example.

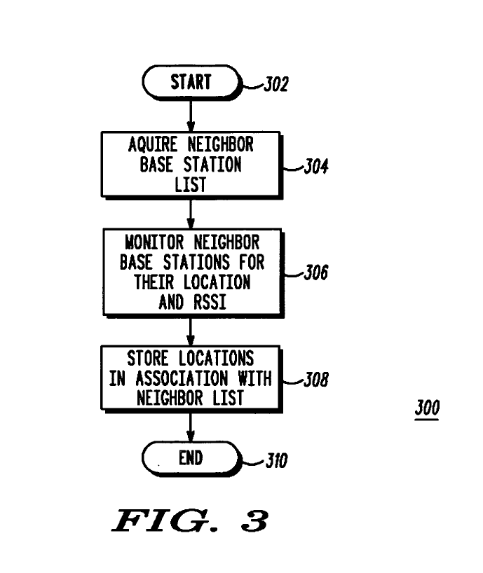

Referring now to FIG. 3, there is shown a flow chart diagram 300 of a method of monitoring neighbor base stations, in accordance with an embodiment of the invention. The process shown here is performed when box 210 of FIG. 2 is reached in the method illustrated there. Thus, the process starts 302 when the method of FIG. 2 reaches box 210, and the device commences monitoring the neighbor base stations of the present base station. The device first acquires the neighbor list from the present base station 304 if the device has not already done so previously. Once the neighbor cell list is acquired, the device commences tuning its cellular communications transceiver to the frequencies or PN sequence offsets of the neighbor base stations. As the mobile communication device receives the control channel broadcasts of the neighbor base stations, it records the signal strengths of the neighbor base stations 306 and locations, if not provided in the neighbor list. This information is then stored in association with the corresponding neighbor base station 308. The process is finished when all the neighbor base stations have been queried, or when time has run out for the neighbor monitor timer. If the device has previously been affiliated with a different base station prior to the present base station, the previous base station may be a neighbor of the present base station, and the device may have already recorded the previous base station's location. However, given that the device has moved and is now affiliated with the present base station, the device must still measure received signal strength.

It should be noted that, although FIGS. 2 and 3 are shown graphically as sequential methods, it will be apparent to those skilled in the art that the various processes illustrated therein may operate in parallel with the operating system checking on each process at various times to determine the status of the process.

Referring now to FIG. 4, there is shown a mapped polygon 400 for determining an approximate location of the satellite positioning receiver in cellular communication network, in accordance with an embodiment of the invention. Here the mobile communication device 404 is within range, and presently affiliated with base station 402, making it the present base station. The present base station has a plurality of neighbor base stations, including neighbor base stations 406, 408. The locations of the neighbor base stations are acquired in accordance with the inventions as described herein with regard to FIGS. 2 & 3. The base stations 402, 406, and 408 form a polygon 410, which, in the instant example, is a triangle, although other polygons may be used. The device 404 calculates or determines the spatial center of the polygon 412. Once the special center is determined, the device may then determine an approximate location 414 of the device by applying signal strength of each base station as a weighting factor to the spatial center. Signal strength weighting moves the approximate location from the spatial center towards the base station producing the strongest signal. Finally, the device, upon determining the approximate location, determines the distance 416 from the approximate location to the present base station. It will be appreciated by those skilled in the art that if only a single neighbor base station is used, instead of multiple neighbor base stations as exemplified here, then the mobile communication device applies the same principle to the line between the present base station and the neighbor base station. The center of the line is determined mathematically, then an approximate position along the line is determined by adjusting the center according to signal strength.

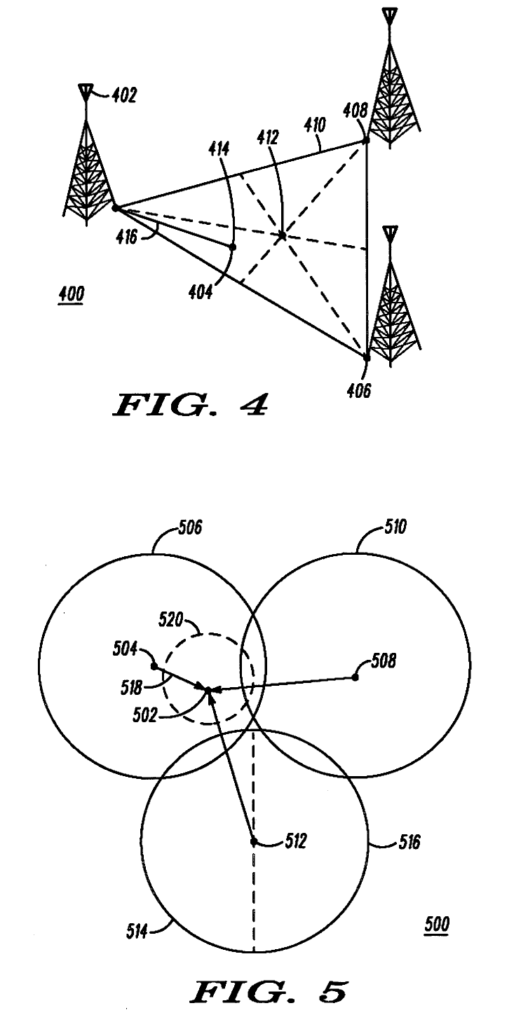

Referring now to FIG. 5, there is shown a cell diagram 500 illustrating how a radius of uncertainty may be determined, in accordance with an embodiment of the invention. Here the mobile communication device 502 is affiliated with a present base station 504 which provides a serving area 506 in the vicinity of the base station. Likewise neighbor base station 508 provides a neighbor cell 510 and neighbor station 512 provides neighbor cell 514. However, Neighbor base station 512 may be a sectored site, which additionally provides serving cell 516. Each sector is assigned a different color code, and thus operate on different frequencies or different PN offsets, typically using different base radios for each sector. In the process of acquiring neighbor base station locations, the two sector are initially treated as separate or different base stations, but upon receiving the location of each, with the location being the same or substantially the same, the mobile communication device will treat the two sectors as a single neighbor base station for the purpose of determining its approximate location. The approximate location is determined similarly as described in reference to FIG. 4. According to one embodiment of the invention, the device, upon determining its approximate location, further determines a radius of uncertainty 520 around the approximate position with the radius being equal to the distance between the approximate position and the present base station.

Thus, the invention provides a method for initiating a first positioning fix with a satellite positioning receiver in a mobile communication device. Process of the method include receiving a location of the present base station and a neighbor list of neighbor base stations of the present base station. The location and neighbor list are received from the present base station, and the neighbor list contains a list of a one or more neighbor base stations neighboring the present base station. The method further includes receiving the locations of at least some of the neighbor base stations of the neighbor list, and determining the spatial center location of the neighbor base station(s) and the present base station. The spatial center is then weighted for determining the approximate position of the mobile communication device by adjusting the spatial center location with received signal strength of each neighbor base station and the present base station. In selecting the neighbor base stations, the device may choose two neighbors having the highest received signal strength and different locations. Additionally, the mobile communication device commences determining the radius of uncertainty around the approximate position, and finally providing the approximate position and radius of uncertainty to the satellite positioning receiver, which then uses the information for performing a location fix. According to one embodiment of the invention receiving the location of the neighbor base stations comprises tuning to a control channel or pseudorandom noise sequence offset of each of the neighbor base stations, and receiving the location of each neighbor base stations over the control channel of each neighbor base stations. Determining the radius of uncertainty may comprise determining the distance from the approximate position to the position of the present base station. The method further may comprise treating any neighbor base stations that are substantially co-located as a single location.

The invention also provides a mobile communication device having a satellite positioning receiver, a cellular communications transceiver, and a processor. The processor operates according to instruction code stored in the device, and determines an approximate position of the mobile communication device and a radius of uncertainty around the mobile communication device. The processor determines the approximate position and radius of uncertainty from the location of the present base station and locations of one or more neighbor base stations. The locations of the neighbor base station(s) and the present base station are received via the cellular communications transceiver, and passed to the processor and stored in memory. The approximate position of the device is determined by weighting the spatial center location between or among the one or more neighbor base stations and the present base station. The approximate position and radius of uncertainty are provided to the satellite positing receiver by the processor to allow the satellite positioning receiver to determine a first location fix of the mobile communication device. The processor may weight the spatial center location in accordance with received signal strength of the present base station and each one of the neighbor base stations. The processor may also determine the radius of uncertainty as the approximate distance to the present base station from the approximate position. The processor, in determining the spatial center location, may treat any neighbor base stations that are substantially co-located as a single location. Furthermore, in selecting the neighbor base stations to use in determining the approximate position, the processor may chose one or two neighbor base stations having the highest signal strength. In one embodiment, the satellite positioning receiver begins an autonomous first fix prior to receiving the approximate location and radius of uncertainty, and recommences the first fix upon receiving the approximate location and radius of uncertainty.

The invention also provides a method of performing an aided position fix in a satellite positioning receiver having an integral cellular communications receiver. The method commences by receiving a control channel broadcast of a first base station, including receiving a location of the first base station, a received signal strength of the first base station, and a list of neighbor base stations. Subsequently the method continues by receiving control channel broadcasts of at least one of the neighbor base stations of the neighbor base station list, including receiving locations neighbor base stations. While receiving the control channel broadcasts of the neighbor base station(s), the satellite positing receiver commences determining and recording the signal strength of the base station(s). One the locations and signal strengths are know, the method commences by determining a spatial center location of a polygon or line formed by the first base station and the neighbor base stations. An approximate position is then determined by weighting the spatial center location according to the received signal strength of the first base station and the neighbor base stations. Additionally, a radius of uncertainty around the approximate position is determined. The position fix is initiated using the approximate position and radius of uncertainty as location aiding information. Furthermore, the integral cellular receiver may be part of a cellular transceiver. The method also may treat two neighbor base stations having the same location as a single neighbor base station for determining the approximate position. The neighbor list may include a color code for each of the neighbor base stations. The color code may include a frequency or pseudorandom noise sequence offset of the control channel for each of the neighbor base stations. Furthermore, the radius of uncertainty may be determined as the distance between the first base station and the approximate position.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for initiating a first positioning fix with a satellite positioning receiver in a mobile communication device, comprising:
receiving at the mobile communication device a location of a present base station and a neighbor list of neighbor base stations of the present base station, the location and neighbor list being received from the present base station, the neighbor list containing a list of a plurality of neighbor base stations neighboring the present base station;
receiving the location of at least one neighbor base stations of the neighbor list;
determining a spatial center location among the at least one neighbor base station and the present base station;
determining an approximate position of the mobile communication device by adjusting the spatial center location by received signal strength of the at least one neighbor base station and the present base station;
determining a radius of uncertainty around the approximate position; and
providing the approximate position and radius of uncertainty to the satellite positioning receiver.

2. A method for initiating a first positioning fix as defined in claim 1, wherein receiving the location of the plurality of neighbor base stations comprises:
tuning to a control channel of the at least one neighbor base station; and
receiving the location of the at least one neighbor base station over the control channel of the at least one neighbor base station.

3. A method for initiating a first positioning fix as defined in claim 2, wherein tuning to the control channel of the at least one neighbor base station comprises tuning to a frequency or a pseudorandom noise sequence offset of the at least one neighbor base station.

4. A method for initiating a first positioning fix as defined in claim 1, wherein the at least one neighbor base station is a plurality of base stations, determining the spatial center location comprises determining the spatial center location of a polygon formed by the plurality of neighbor base stations and the present base station.

5. A method for initiating a first positioning fix as defined in claim 1, wherein determining the radius of uncertainty comprises determining the distance from the approximate position to the position of the present base station.

6. A method for initiating a first positioning fix as defined in claim 1, further comprising determining an location fix of the mobile communication device with the approximate position and radius of uncertainty.

7. A method for initiating a first positioning fix as defined in claim 1, wherein determining the spatial center location comprises treating any neighbor base stations that are substantially co-located as a single location.

8. A method for initiating a first positioning fix as defined in claim 1, wherein determining the spatial center location of the plurality of neighbor base station comprises selecting two neighbor base stations having a highest signal strength to form a triangle with the present base station.

9. A mobile communication device, comprising:
a satellite positioning receiver;
a cellular communications transceiver; and
a processor for determining an approximate position of the mobile communication device and a radius of uncertainty around the mobile communication device, the processor determining the approximate position and radius of uncertainty from the location of a present base station and a locations of at least one neighbor base station, the approximate position being determined from weighting a spatial center location of the at least one neighbor base station and the present base station;
wherein the approximate position and radius of uncertainty are provided to the satellite positing receiver for determining a first location fix of the mobile communication device;
wherein the locations of the at least one neighbor base station and the present base station are received via the cellular communications transceiver.

10. A mobile communication device as defined in claim 9, wherein the processor weights the spatial center location in accordance with received signal strength of the present base station and each one of the at least one neighbor base station.

11. A mobile communication device as defined in claim 9, wherein the processor determines the radius of uncertainty as the approximate distance to the present base station.

12. A mobile communication device as defined in claim 9, wherein the processor, in determining the spatial center location, treats any neighbor base stations that are substantially co-located as a single location.

13. A mobile communication device as defined in claim 9, wherein the satellite positioning receiver begins an autonomous first fix prior to receiving the approximate location and radius of uncertainty, and recommences the first fix upon receiving the approximate location and radius of uncertainty.

14. A mobile communication device as defined in claim 9, wherein the processor determines the spatial center location of the at least one neighbor base station by selecting two neighbor base stations having a highest signal strength to form a triangle with the present base station.

15. A method of performing an aided position fix in a satellite positioning receiver, comprising:
receiving a control channel broadcast of a first base station, including receiving a location of the first cellular base station, a received signal strength of the first base station, and a list of neighbor base stations;
receiving control channel broadcasts of at least one neighbor base station of the neighbor base station list, including receiving a location of each of the at least one neighbor base station;
while receiving the control channel broadcasts of each of the at least one neighbor base station, determining and recording a signal strength of each of the at least one neighbor base station;
determining a spatial center location between the first base station and the at least one neighbor base station;
determining an approximate position of the satellite positioning receiver by weighting the spatial center location according to the received signal strength of the first base station and the at least one neighbor base station;
determining a radius of uncertainty around the approximate position; and
initiating the position fix with the approximate position and radius of uncertainty.

16. A method of performing an aided position fix as defined in claim 15, wherein receiving the control channel broadcasts of the first and at least one neighbor base station is performed by a cellular communications transceiver.

17. A method of performing an aided position fix as defined in claim 15, wherein if, upon receiving the location of the at least one neighbor base station, two of the neighbor base stations have the same location, treating the two neighbor base stations as a single neighbor base station.

18. A method of performing an aided position fix as defined in claim 15, wherein receiving the neighbor base station list comprises receiving a color code for each of the neighbor base stations.

19. A method of performing an aided position fix as defined in claim 18, wherein the color code includes one of a frequency or a pseudorandom noise sequence offset of the control channel broadcast for each of the neighbor base stations.

20. A method of performing an aided position fix as defined in claim 15, wherein the radius of uncertainty is determined as the distance between the first base station and the approximate position.
